(19) United States
(12) Patent Application Publication
(10) Pub. No.: US 2012/0042796 A1
(43) Pub. Date: Feb. 23, 2012

(54) NEWSPAPER PRODUCT AND METHOD AND APPARATUS FOR PRODUCING A PRODUCT

(76) Inventors: Burkard Otto Herbert, Wurzburg (DE); Kurt Anton Heublein, Zellingen (DE); Stefan Wander, Helmstadt (DE); Klaus Weber, Isernhagen (DE)

(21) Appl. No.: 13/138,794

(22) PCT Filed: Mar. 22, 2010
(86) PCT No.: PCT/EP2010/053665

§ 371 Date: Nov. 1, 2011

(30) Foreign Application Priority Data
Apr. 1, 2009 (DE) 1020090020918

(51) Int. Cl. B41F 5/00

(52) U.S. Cl. 101/216; 101/483

(57) ABSTRACT

A newspaper product or product section has at least one first quire and at least one second quire which is at least two pages in width. In the closed state, the at least two quires are arranged such that each is folded longitudinally along a longitudinal folding line, and lie one inside one another. The at least two quires have, next to one another, on both sides of the longitudinal fold line, two vertical printed pages or one printed image which is spread over two vertical printed pages. An inner one of at least two quires, which are at least two pages in width, has an outer region which can be folded open, at least on a longitudinal side of the longitudinally folded outer region which is at least two pages in width. The longitudinal side extends parallel to the longitudinal folding line. In the area of its lateral edge, the outer region, which can be folded open, is joined in a material-to-material manner, to the lateral edge region of the center region which is two pages in width. In the folded open state, the outer region protrudes beyond the width of the remaining product and continues the center region laterally. A method and apparatus for producing the product is described.

### CROSS-REFERENCE TO RELATED APPLICATIONS

This application is the U.S. national phase, under 35 U.S.C. 371, of PCT/EP2010/053665, filed Mar. 22, 2010; published as WO2010/112357 A1 on Oct. 7, 2010; and claiming priority to DE 10 2009 002 091.8, filed Apr. 1, 2009; the disclosures of which are expressly incorporated herein by reference.

### FIELD OF THE INVENTION

The invention relates to a newspaper product and to a method and an apparatus for producing a product. A newspaper product or a product section is comprised of at least one outer signature, two pages in width, and at least one inner signature, at least two pages in width. The at least two signatures, in their closing condition, are each folded longitudinally along a longitudinal fold line and are arranged one inside the other. The at least two signatures have two vertical printed pages on both sides of the longitudinal fold line. The product is produced in a printing press, such as a newspaper printing press that has at least one printing unit through which at least one web passes. The printing unit comprises a plurality of printing couples, each having one forme cylinder. The product to be produced has an extra wide signature comprising a center region, and which is two pages in width and has a longitudinal fold. This extra wide signature has, on at least one side of the center region, an outer region that forms a continuation of the center region. The printing press produces two imprinted web strands one of which is guided on top of the other. The printing unit may be configured as at least one printing tower through which the web passes vertically. The printing unit also has a superstructure with a former structure having at least one longitudinal fold former.

### BACKGROUND OF THE INVENTION

DE 10 2004 033 920 B4 discloses a web-fed rotary printing press, wherein in one embodiment, a longitudinally folded product having fold-out pages that are folded in on one or on both sides can be produced. For this purpose, a web having a width of more than two or more than three pages is folded in on one or on both sides by a plough folder, and is then folded longitudinally over a fold former.

DE 297 13 744 U1 involves a particular embodiment for dispensing heads of a longitudinal or cross gluing apparatus. In one embodiment, two webs are guided one above the other upstream of a longitudinal fold former, wherein upstream of a fold former, a longitudinal bead of glue is applied to the upper side of the lower web at the ¼ and ¾ widths and to the upper side of the upper web, and, at the output of the fold former, to the underside of the lower web at the ¾ width. A product consisting of eight pages folded at the center and glued into one another can thereby be produced.

DE 25 58 049 A1 discloses a method and an apparatus for producing a printed product, wherein two partial webs measuring two pages in width are guided one above the other. In order to make a product section of the final product removable, the two webs guided one on top of the other are joined to one another, parallel to what will later be the first longitudinal fold line, by a bead of glue. The bead of glue is preferably located 12 mm to the side of the longitudinal fold line. Between longitudinal fold line and glue bead, the two webs are perforated by a perforating device, which allows the glued product section to be removed without destroying the product.

In DE 76 29 914 U1, a product comprising a plurality of webs that are glued to one another longitudinally and are perforated longitudinally is produced, wherein after being joined longitudinally, the product is cut into multilayer product sections, cross-folded, and then folded longitudinally. The two webs are joined to one another eccentrically, so that part of a collection of pages to be produced by the apparatus can be prevented from unfolding, or can be separated from the remaining part. In order for this to be carried out substantially without destroying the product, the joined strand is embodied as perforated in the region between glue bead and web center.

DE 71 29 190 U discloses a method and an apparatus, wherein a wider web is folded longitudinally at the center on a fold former. Prior to longitudinal folding, the web to be folded at the center is provided with glue close to the center, for the purpose of joining said web to a half-width web upstream of folding. After longitudinal folding, the glued single page is folded in by the folded pages of the wider web.

DE 30 16 573 A1 discloses a method for producing products, and products, which method allows a multi-page insert to be handled as a separate component. For this purpose, different patterns of glue beads and longitudinal perforations are provided in various embodiments. With these, a product section can be removed from the product in the region of the perforation without destroying the product. In one embodiment, one leg of a partial web is first folded in by longitudinal folding, and is then glued to the remaining web width. The gluing is spaced from the edge of the leg that has been folded over, in order to ensure later removal along a perforation.

WO 84 03258 A1 discloses a method by which an object, for example, a pair of glasses, can be inserted into a multi-section product. For this purpose, one section is provided with a central region that supports the object, and two flaps, one of which can be folded over the object. The section that contains the folded-in flap, together with the other flap, forms a section that is folded along the spine in the product.

EP 1 037 749 A1 discloses a printed product and a method for producing said product. In this case, the entire printed area of the product is no longer to be predetermined on the basis of the page jumps for entire printed pages defined by the printing press, and instead, the option of only partial-width pages is to save on materials and costs. Within a folded, outer double page is at least one page having a smaller format in relation to the outer section. This page of smaller format can then be arranged in different ways inside the product. It can be arranged symmetrically with the fold line, with one lateral edge flush with the fold line, or with one lateral edge flush with the outer section. It can be loose, or fastened by a strip of adhesive to the section that lies closer to the outside. Depending on the configuration, in production, one narrower web and one wider web are combined with their outer edges symmetrical with one another, with one outer edge of the narrower web aligned with the fold line, or with outer edges aligned on one side.

### SUMMARY OF THE INVENTION

The problem addressed by the invention is that of devising a newspaper product, a method, and an apparatus for producing a product, particularly a newspaper product.

The problem is solved according to the invention by the provision of the at least one inner signature with a fold-out outer region, at least on a longitudinal side of its longitudinally folded center region, and which is two pages in width, and which longitudinal side extends parallel to the longitudinal fold line. This fold-out outer region is joined, by adhesive, in the region of its lateral edge, to the lateral edge region of the two-page-wide center region and forms an extra-wide signature with the center region and the outer region. This fold-out region, in its folded open condition, extends beyond the width of the remainder of the product and forms a lateral continuation of the center region. A primary image of a continuous illustration is formed on the folded-over, extra-wide signature and extends across more than two pages without a white strip. A second web strand forms the outer region of the extra-wide signature in the product and which is adhesively joined to an outer edge region of a first web strand. A resultant web strand is guided to a fold former for longitudinal folding. The superstructure which guides the web or webs has guide elements such that the first web strand, which has two pages and which forms the center region in the product, and the second web strand which forms the outer region of the product, can be guided on top of one another so that lateral edges of each lie in the same alignment, at least on the same side of the strand. A dispensing unit may be disposed upstream of the former structure and on the web path of one of the two strands and is used to apply the adhesive material to an edge region of one of the two webs. The two web strands are in contact with each other as they are merged upstream of the former structure or on a roller disposed upstream of a fold former, and can be adhesively joined to one another.

The benefits to be achieved with the invention consist especially in that in the product, particularly the newspaper product, one signature having an extra-wide section, which can particularly be folded open, is produced, or can be produced in a simple manner inline. With this, it is possible to position very long printed images, for example, for advertisements, in newspaper products during inline production. The newspaper product then contains a folded signature which, after being folded open, has the width of three or four newspaper pages (particularly vertical newspaper pages or broadsheet pages). This signature is preferably guided to the fold former as the lowermost signature of optionally multiple signatures. The broadsheet newspaper product is usually characterized in that, after being cross-cut, it has been gripped in the folding apparatus by holding elements at an upper or lower edge of the vertical page of the finished product (i.e., the product that will be opened by the reader at the cross fold), and therefore, gripping tracks, for example, puncture points or gripper impressions, are visible at the upper or lower edge (head or foot of the page). On the uncut tabloid product, gripping tracks of this type would be expected on a right or left longitudinal side.

As a result of this process, there is no white edge—which is otherwise frequently customary—i.e., a continuous illustration, such as an automobile, for example, can extend across up to four pages, without a white strip.

In one advantageous further development, a drying apparatus is provided at least in one web path of a web to be processed, particularly the web that forms the extra-wide signature, and/or a web is formed from a print substrate of higher surface quality and/or base weight and/or coat weight.

At least one other of the webs to be processed to produce a combined product can then be formed from another print substrate, for example, from newsprint paper (e.g., open-pored and/or uncoated or lightly coated).

### BRIEF DESCRIPTION OF THE DRAWINGS

Embodiment examples of the invention are illustrated in the set of drawings and will be specified in greater detail in what follows.

The drawings show:

FIG. 1 an example of a newspaper printing press;

FIG. 2 a schematic illustration of a product having an extra-wide signature;

FIG. 3 a diagram illustrating the principle of the production of an extra-wide signature, in a first embodiment a) and in a second embodiment b), and an illustration of the resulting signature c);

FIG. 4 a schematic plan view of the principle of the method according to the embodiment of FIG. 3b);

FIGS. 5 5a) and 5b) schematic illustrations of possible forme cylinder loading configurations, 5c) the procedure according to 3b), and 5d), the resulting signature;

FIG. 6 examples of longitudinally folded, extra-wide signatures having various edge page widths;

FIG. 7 a diagram illustrating the principle of the production of another extra-wide signature in a first embodiment a) and in a second embodiment b), and an illustration of the resulting extra-wide signature c);

FIG. 8 an example of an extra-wide signature, and the production thereof in another embodiment;

FIG. 9 a perspective illustration of an embodiment example of the product or of a product section.

### DESCRIPTION OF THE PREFERRED EMBODIMENT

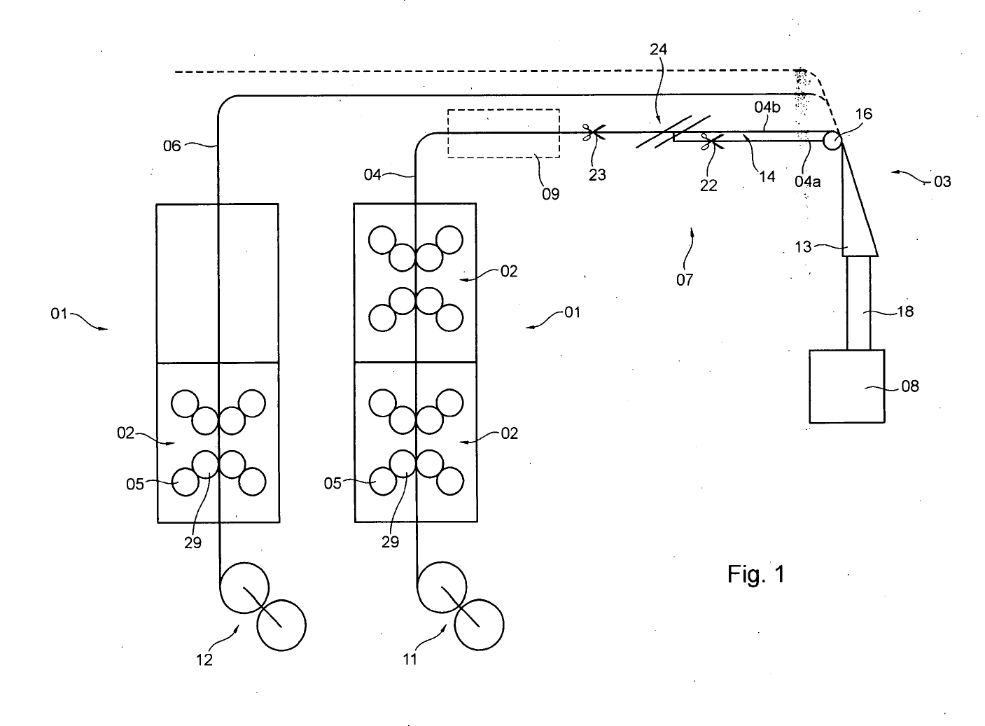

FIG. 1 shows an example of a printing press embodied as a web-fed rotary printing press, particularly a newspaper printing press. The press is characterized, for example, by at least two printing towers 01 configured for production on a shared former structure 03, and/or, for example, by at least two webs 04; 06 imprinted on both sides with multicolor ink in printing units 02. Said webs can be processed together in a folding apparatus 08 to produce a product, particularly a newspaper product, after passing through a superstructure 07 of the former structure 03. A cross-cutting apparatus that cuts the strand 18 crosswise into product sections is positioned downstream of the fold former 13 and is either assigned to the folding apparatus 08 or positioned upstream thereof in the strand path.

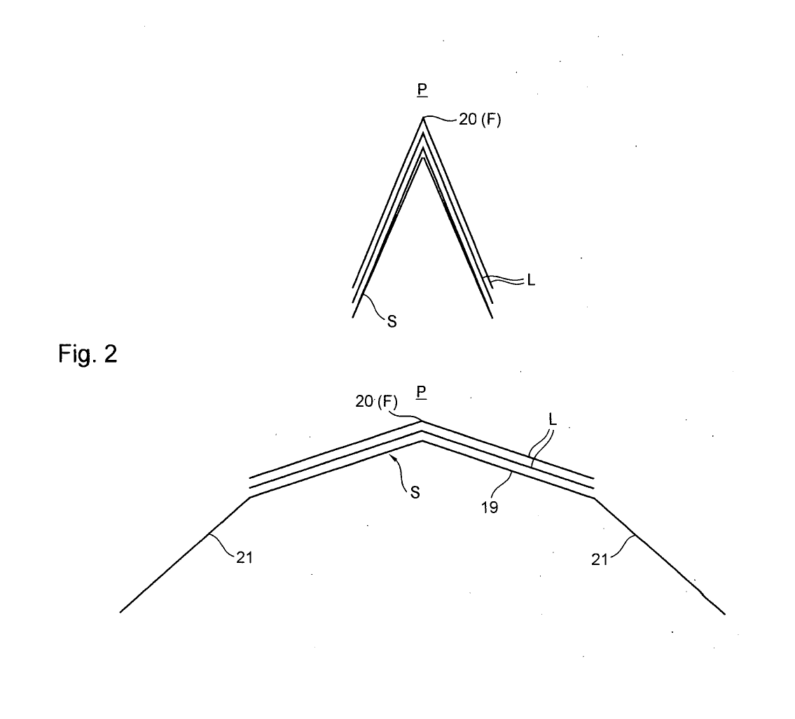

The printing press is configured, for example, for producing conventional newspaper products comprising one or more signatures, each having the width of one or two newspaper pages when opened. The newspaper pages are preferably produced in broadsheet configuration, i.e., the printed pages of the final product will be or are oriented on the web in such a way that the head and foot of the pages thereof are spaced in the longitudinal direction of the web, or the left and right page edges thereof extend parallel to the edge of the web. Accordingly, the exposed printing formes for the printed pages are arranged on the forme cylinder vertically in the circumferential direction. In addition to conventional newspaper (broadsheet) products, the newspaper printing press specified herein is also configured for producing products P identified here as “P”, particularly newspaper products P, which have at least one signature S, for example, extra-wide signature S, which, when fully opened, has a width of more than two, preferably more than three pages of the relevant newspaper format (FIG. 2). The product P (or product section) can then have one or more signatures L that are two pages or one page in width (“normal”), and at least one extra-wide signature S, preferably as an inner signature of the strand section or product section (also called a book or section).

The printing units 02 can be embodied as single-width, double-width or triple-width printing units 02, wherein single-width refers to a usable printing width of printing couple cylinders 05, for example, forme cylinders 05 that support the print master, which means two printed pages, particularly vertical newspaper pages, in a format that is identified as standard for the printing press. A signature L that is one or two pages in width represents a single page or a double page, customary in newspaper printing, in the applicable format for the product P in question (format of the newspaper product that is closed at the fold spine, i.e., at the longitudinal fold 20 of the outermost signature L, for example, along a longitudinal fold line F). The double page can also be imprinted with a continuous print image, called a double-page spread, in which case the longitudinal fold line F extends perpendicularly along the center of the double-page spread. The width of the extra-wide signature S, when fully opened up, then corresponds to more than twice the width of the format currently in question.

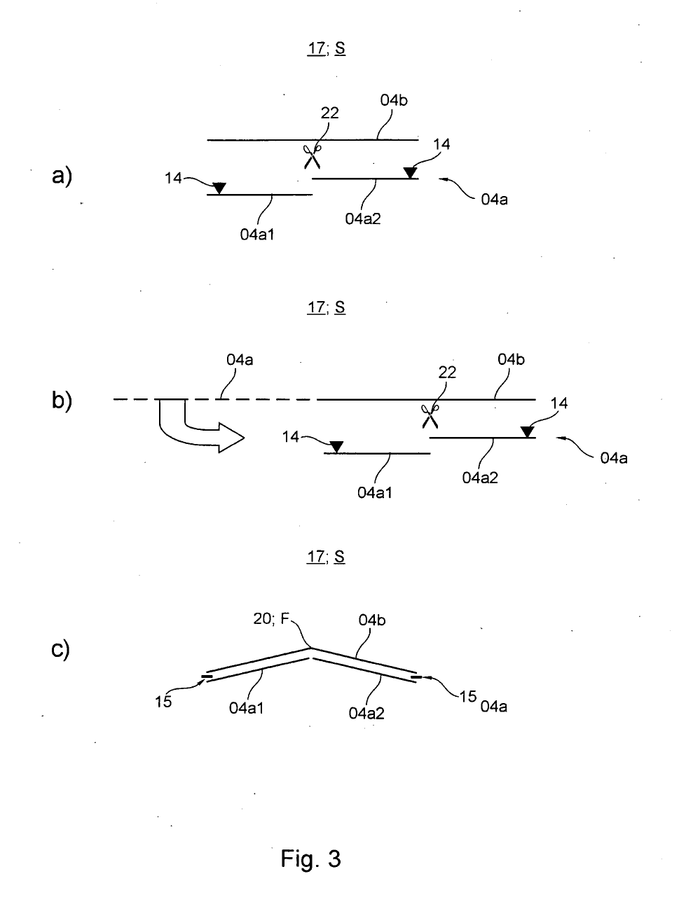

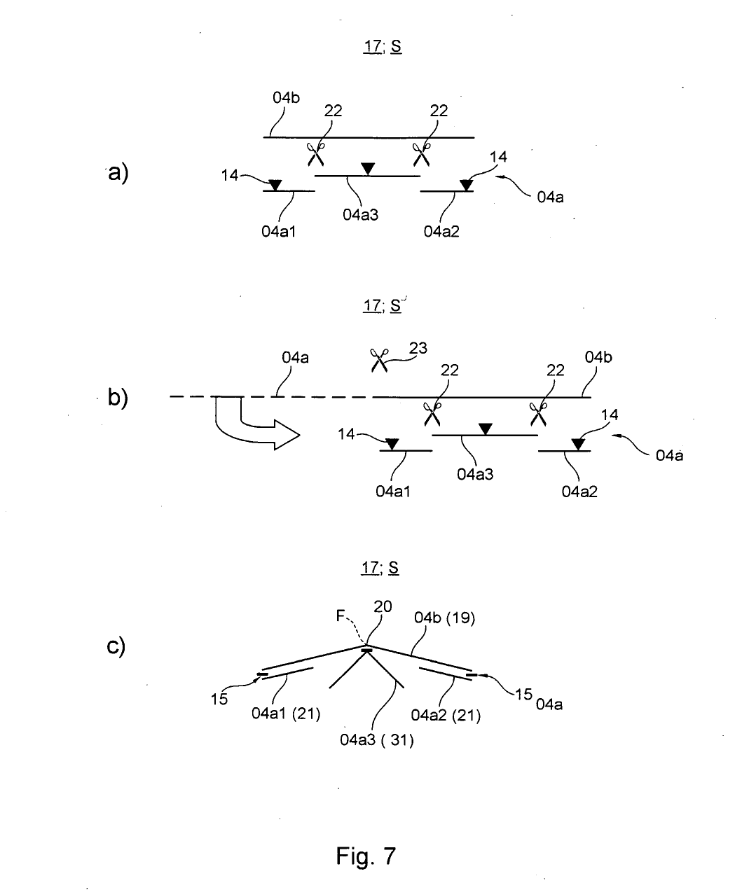

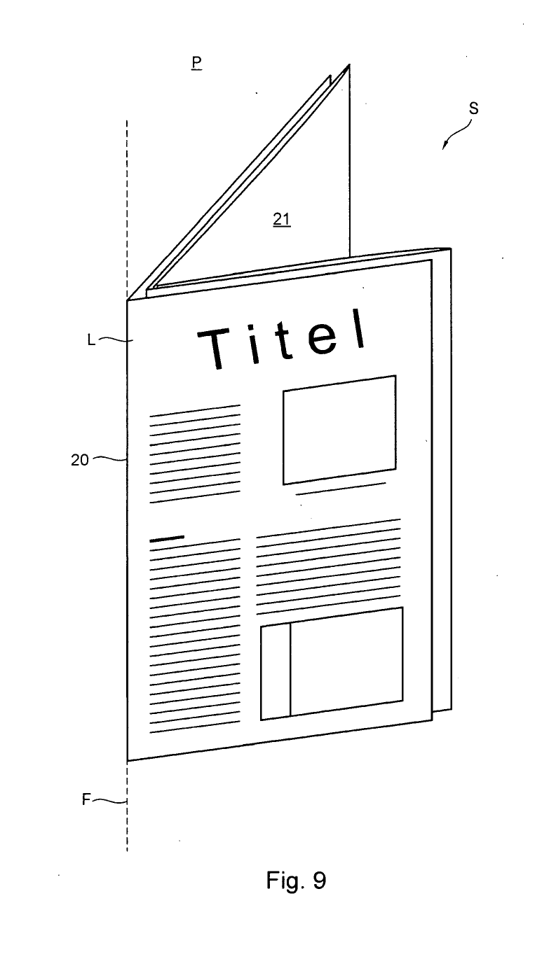

In the illustrations of FIGS. 2 to 8, the longitudinal fold line F is not shown as a line, and instead extends in the region of the “knee” indicated by way of example in FIGS. 3c and 7c, perpendicular to the plane of the sheet. In relation to the finished product P, said fold line extends perpendicular to the alignment of a line of text optionally provided on the first page (title page), for example, the headline. In the interest of clarity, FIG. 9 shows a simplified product or a product section, for example, having a “normal” signature L that is folded around a special signature S, with the fold line F of the signature L indicated, and with a headline and the primary text direction shown from a perspective view.

The web 04 or the webs 04; 06 is or are preferably imprinted in printing towers 01. These are characterized in that in the printing tower 01, the web 04; 06—at least between a fourth and a fifth print position that interacts with the web 04; 06—has a substantially vertical travel direction (e.g., having at most ±15° deviation from vertical). This embodiment can be used in newspaper printing presses, for the purpose of allowing multiple webs 04; 06 to be imprinted and processed inline to produce a combined product P, particularly a newspaper product P. In this case, a printing tower 01 can have a plurality of stacked blanket-to-blanket printing units, stacked H-printing units, or stacked satellite printing units, each having at least eight print positions, for example.

In one advantageous embodiment of the newspaper printing press, said press has at least one dryer 09, for example, a dryer 09 based upon radiation (IR or UV dryer) or advantageously a thermal dryer 09 (hot air dryer), through which at least one of the webs 04; 06, embodied as a heatset web 04, for example, can be guided on a web path. In one advantageous embodiment, said web 04 or said webs 04; 04a; 04b (see below), as a heatset web 04, which has or have the printed pages of the extra-wide signature S (also called a super spread) to be formed in the product P, is guided through an or the activated dryer 09.

In principle, the print substrate of a web 04, which is unwound from a reel changer 11, and which, after imprinting, contains the printed pages of the extra-wide signature S to be produced, and a web 06, which is unwound from a reel changer 12 and is for a “normal” signature L that is different from the first, can be the same print substrate. In this case, the normal signature L can be understood as a signature L which, in the opened condition, has a maximum width of two pages of the format in question.

In an advantageous further development, the web 04; 04a; 04b that contains the printed images of the extra-wide signature S to be produced and/or the web that is guided through the dryer 09 can be fed in as glazed and/or heavily coated paper having a coat weight greater than 10 g/m², for example, greater than 15 or even greater than 20 g/m². The paper can be embodied as medium or high quality paper, within a base weight range of greater than 40 g/m², for example, within a base weight range of 55-90 g/m², particularly greater than 50 g/m². The Bekk smoothness factor (according to DIN 53107), at least on the smoother side, is preferably at least 70.0 s, more particularly, at least 100.0 s. However, the web 04; 04a; 04b that contains the printed pages of the subsequent extra-wide signature S can also be embodied, as necessary, as the same print substrate or as having the same print substrate quality as one or more of the other signatures L of the finished product P that are not extra-wide, for example, of newsprint paper.

In one embodiment of the printing press or of the method, a web 06 or webs 06, which contains or contain only printed images of signatures L not allocated to the extra-wide signature S, are formed from newsprint paper or from a print substrate that is at least similar to newsprint paper. This can be, for example, uncoated or only lightly coated paper having a maximum coat weight of 20 g/m², for example, no more than 10 g/m², particularly no more than 5 g/m². It can also be embodied as enhanced newsprint paper. The print substrate of the web 06 has a maximum base weight of 65 g/m², for example, and in the case of uncoated newsprint paper, for example, a maximum of 50 g/m² or even a maximum of 40 g/m². The Bekk smoothness factor (according to DIN 53107)—at least on the smoother side, for example,—is advantageously less than 70.0 s, for example, particularly less than 60.0 s. In one embodiment, this web 06 or these webs 06, as coldset webs 06 which are not used to produce the extra-wide signature S, is or are not guided through an activated dryer.

In one advantageous embodiment, therefore, two webs 04; 06 of different variants or quality are provided for the web 04 that contains the extra-wide signature S, and for a signature L that is different from the first. The web 04 (04a; 04b) that contains the subsequent extra-wide signature S passes through a dryer 09, for example. In this manner, the extra-wide signature S can be provided with a higher quality print image, and/or can be formed from a higher quality print substrate.

As is illustrated in FIG. 1, one or more webs 04; 06 or partial webs 04a; 04b; 06 produced by one or more longitudinal slitters 22; 23 are guided to the former structure 03. The former structure 03 has at least one fold former 13.

To produce an extra-wide signature S or a product P having at least one extra-wide signature S, at least two webs 04 or partial webs 04a; 04b, the width of which is no greater than that of the fold former 13 downstream, for example, are then guided one on top of the other before they run up to the fold former 13. In what follows, the partial webs 04a; 04b to be guided to the fold former 13 are also referred to as web strands 04a; 04b. For the case in which printing units 02 and/or webs 04; 06 guided through the printing unit(s) 02 are embodied as only single-width, these webs 04; 06, which are guided to the fold former 13, or partial webs 04a; 04b which are cut from these webs by longitudinal slitting, are also referred to as web strands 04a; 04b.

Regardless of whether the relevant web strands 04a; 04b are produced from the same web 04 (original web) or from two different webs 04, the extra-wide signature S is produced in such a way that a web strand 04b that is two pages in width and at least one web strand 04a; 04a1; 04a2 that is no more than one page in width, or a web strand 04a1; 04a2, for example, partial web strand 04a1; 04a2, which is no more than one page in width and is produced from a web strand 04a by longitudinal slitting, for example, partial web strand 04a1; 04a2, are guided one above the other, before they run up to the fold former 13, in such a way that the narrower and wider web strands 04b; 04a1; 04a2 are disposed one above the other, wherein the web edges on the same strand side are aligned with one another in the vertical direction. In the region of the web edge of one of these web strands 04b; 04a1; 04a2 guided one above the other, an adhesive material 15, for example, glue 15, is applied by means of an appropriate dispensing unit 14, for example, a gluing unit. As they are merged upstream of the former structure 03 or on a roller 16, for example, a nip roller or former intake roller 16, disposed upstream of the fold former 13, the two web strands 04b; 04a1; 04a2 to be joined at their edges then come into contact with one another, and are adhesively fastened to one another along the edge regions by the glue 15, forming a strand 17 that will form the subsequent signature S. In this case, the edge regions on the same side of the strand with respect to the transverse direction thereof, which lie opposite one another, are joined to one another, and therefore, the web strands 04b; 04a1; 04a2 to be joined to one another come to rest not adjacent to one another, but on top of one another. The resulting strand 17 is then guided—alone or, for example, together with one or more web strands 06 that are one or two pages in width—over the fold former 13, and is folded longitudinally to a folded strand 18. If this strand 17 produced by joining is guided, together with other web strands 06 that are one or two pages in width, over the same fold former 13, then the strand 17 that forms the signature S is preferably positioned as the lowest or innermost signature, which interacts directly with the fold former 13.

As was specified above, the web strand that is two pages in width, for example, and a partial web strand 04a1; 04a2 are joined to one another along their mutually aligned edges or web edges. For this purpose, glue 15 is applied to the edge region of the relevant web edge of at least one of the web strands 04b; 04a; 04a1; 04a2 to be joined. The glue is applied nearly directly adjacent to the web edge, for example, spaced at most 20 mm, preferably at most 15 mm, particularly at most 10 mm, from the relevant web edge. In this manner, the two web strands 04b; 04a1; 04a2 are joined to one another along their edges, so that, for example, the double signature joined in this manner along the edge cannot be opened without breaking the glued connection—apart from a slight spreading (for example, up to a few mm, for example, at most 5 mm deep). This can be the case when the glue is applied at a clearance of a few millimeters, for example, 1 to 15 mm, in order to prevent the glue from escaping along the side resulting in a soiling of the rollers downstream. The glue is therefore preferably applied in a strip spaced 1 to 15 mm from the relevant web edge of the center region 19, parallel to the longitudinal fold line F. The adhesive connection is therefore produced, for example, within a strip spaced 0 to 20 mm, preferably 1 to 15 mm, from the relevant web edge of the center region 19, and parallel to the longitudinal fold line F.

FIG. 2 shows an example of an extra-wide signature S produced by the above-described joining process, or a product P containing said signature. As was already specified above, said product contains at least one extra-wide signature S. This signature has a center region 19 that is two pages in width and has a center longitudinal fold 20, and an outer region 21 on at least one side of the center region 19, said outer region forming a continuation of the center region. This outer region 21 is formed by the above-described web strand 04a1; 04a2, which is preferably no more than one page in width and is joined to the center region 19 by gluing. In one advantageous, illustrated embodiment, an outer region 21 is provided on both sides of the center region 19 and forms a continuation of said region. This outer region 21 is positioned covering the center region 19, but can be folded open as a fold-out page 21. Therefore, taking into consideration the width of the joint that is produced by gluing, a printed image that extends over more than two pages, for example, a continuous printed image, can be produced. The print images disposed on the forme cylinders 05 for the center region 19 and the outer region 21 are to be appropriately exposed and/or aligned for this purpose.

In principle, the web strands 04a1; 04a2; 04b that form the strand 17 or form the extra-wide signature S in the product P can come from the same web 04, which is four or six newspaper pages in width, for example, from partial webs 04a1; 04a2; 04b of different webs 04 that are four or six newspaper pages in width, or from different webs 04 (04a1; 04a2; 04b) that are one or two newspaper pages in width, for example. The same applies to one or more webs 06, which form one or more signatures L that are different from the extra-wide signature S.

In FIG. 3a), the strand 17 or of the extra-wide signature S is formed, by way of example, from two webs 04 or 04a; 04b, which are originally two pages in width. In this case, the web 04; 04a that forms the subsequent fold-out pages 21 is slit longitudinally, for example, at the center, by a longitudinal slitter 22 to form the two web strands 04a1; 04a2. If a fold-out page 21 is to be provided on only one side, a partial web 04a1, which is a maximum of one page in width, for example, can be guided as web strand 04a1, without another cut. Before running up to the roller 16, glue 15 is then applied to one of the web strands 04a1; 04a2; 04b between the aligned edges.

The guidance of the two webs 04a and 04b illustrated in FIG. 3a) can also be used when the two webs 04a and 04b are web strands 04a and 04b, which are produced by longitudinally slitting two different webs 04 that were previously double width or triple width, and guiding these one on top of the other without turning.

The illustration of the web strands 04a1 and 04a2 in the drawings of FIGS. 3, 5 and 7 is offset in the interest of clarifying the web strands 04a1 and 04a2 (or 04.a3 in FIG. 7), which are otherwise adjoining, nearly uninterrupted, up to the line of intersection. Preferably, these web strands 04a1; 04a2 (04a3), which are partial width (no more than one page in width) when a plurality of strands are to be joined to the web strand 04b, enter the former structure 13 or a roller 16 upstream thereof in the same plane.

FIG. 3b) shows an advantageous example of the formation of the strand 17 or of the extra-wide signature S using web strands 04a1; 04a2; 04b from partial webs 04a; 04b of the same web 04 that was originally four pages in width (or partial web, four pages in width, of a web that was originally six pages in width). In this case, first the web 04 that is four pages in width is slit longitudinally by a longitudinal slitter 23 to form one partial web 04b; 04a that is two pages in width and one partial web 04a; 04b that is no more than two pages in width, and downtream, either the partial web 04b; 04a that will subsequently form the center region 19 or the partial web that will subsequently form the fold-out pages 21 is turned by means of a turning device 24, for example, a pair of turner bars 24, into the alignment of the respectively other partial web 04a; 04b, i.e., is offset laterally. The partial web 04a that will subsequently form the fold-out pages 21 is slit longitudinally at the center, for example, by means of the longitudinal slitter 22, into the two web strands 04a1; 04a2. If a fold-out page 21 is to be provided on only one side, then only one partial web 04a, a maximum of one page in width, can be produced from the web 04 by means of the longitudinal slitter 23, for example. As in the above example, before it runs up onto the roller 16, glue 15 is applied to one of the web strands 04a1; 04a2; 04b between the aligned edges.

The guidance of the two webs 04a and 04b illustrated in FIG. 3b) can also be used when the two web strands 04a and 04b have been produced not from the same web 04, but from two different double-width or triple-width original webs. In that case, one of the web strands 04a; 04b produced by longitudinal slitting would again be turned with one web edge into the alignment of a web edge of the other web strand 04b; 04a.

FIG. 3c) schematically illustrates the strand 17 produced in this manner, which forms the extra-wide signature S in the product P.

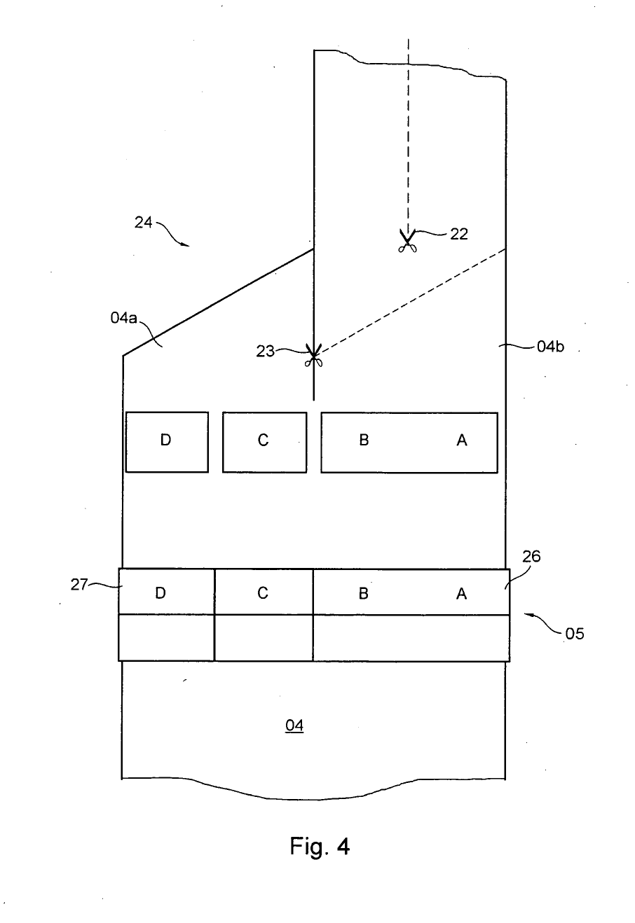

In FIG. 4, the procedure is illustrated from a plan view, within the context of a web 04 to be imprinted, which is four pages in width. In this case, a possible loading configuration for the forme cylinder 05 with print images A, B, C and D is illustrated by way of example, wherein the continuous lines on the forme cylinder 05 symbolize a possible arrangement of printing formes 26; 27. In the example, a double-page printing forme 26 that carries two printed pages side by side is positioned in the alignment of the partial web 04b that will subsequently form the center region 19. A printing forme 26 of this type could also be positioned on the side that is aligned with the other partial web 04a. In this example, however, two printing formes 27, each carrying one print image C; D of a printed page, are provided.

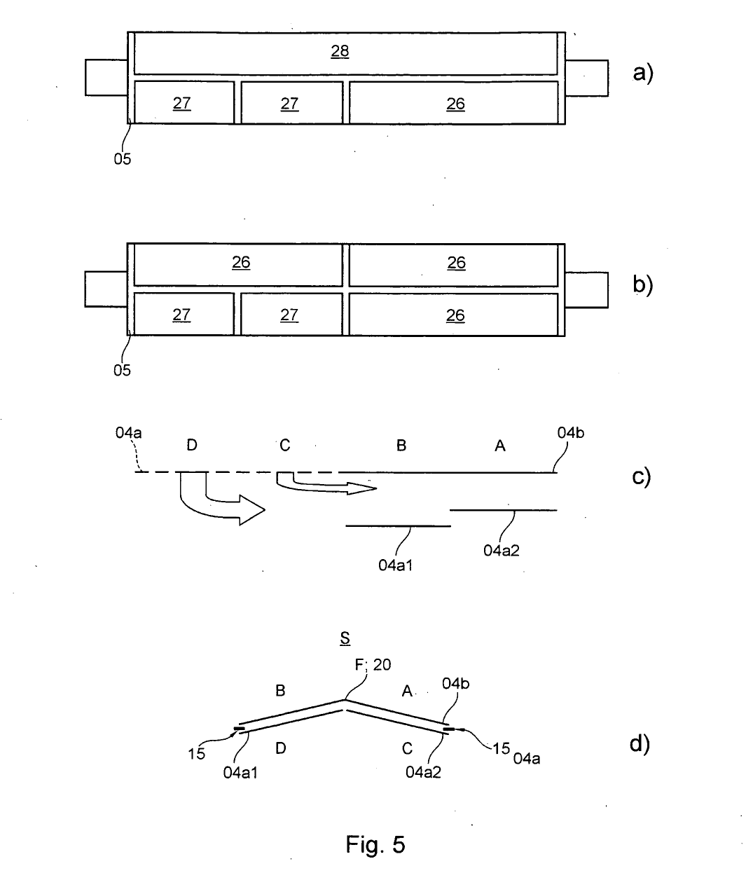

FIG. 5a) and b) show additional different possibilities for loading the form cylinder 05 with printing formes 26; 27; 28 side by side. For instance, as shown on the top in FIG. 5a), one printing forme 28 can extend over the entire width. However—as shown on the bottom in FIG. 5a) and on the bottom in Fig. b)—one printing forme 26 two pages in width and two printing formes 27 one page in width can also be disposed side by side, according to the example of FIG. 4, or, as shown on the top in FIG. 5b), two printing formes 26 two pages in width can be disposed side by side. In the case of a double-sized forme cylinder 05 (two printed pages, one in front of the other in the circumferential direction), it can be advantageous to provide the same pattern of printing formes 26; 27; 28 arranged side by side in both rows. FIG. 5c) illustrates the above-described lateral offset with an indication of the printed pages, and FIG. 5d) illustrates the strand 17 or the extra-wide signature S that can be folded out. If it is necessary to turn one of the involved web strands 04a; 04b; 04a1; 04a2 in order to produce the product, then for turning, it is advantageous not to turn the partial web strand that is no more than one page in width, for example, and instead, if applicable, to turn the web or the web strand 04a that is two pages in width, from which the partial web strand 04a1; 04a2 will be produced by longitudinal slitting only after turning. A partial web strand 04a1; 04a2 of this type can also be formed by separation from a ¾ strand (e.g., three pages in width) in the case of a double-width printing press, or from a ½ strand (e.g., three pages in width) in the case of a triple-width printing press.

In one embodiment, a printed image that extends across the entire folded-open width can be provided across the folded-open, interior side of the signature S, i.e., across the center region 18 and the outer region or regions 21. For this purpose, the printing forme intended for the outer region 21 and the printing forme intended for the adjoining inner region are preferably exposed in such a way that, on the side of the printing forme that represents a mutual continuation of the printing forme, the same printed image section is provided. In other words, on the printing formes that carry the continuing printed images, a common overlapping region of the print image that repeats on both printing formes is provided, and is provided on both printing formes. This overlapping region can measure at least 0.5 mm, for example, particularly at least 1 mm. In this manner, the risk is diminished that—for example, due to inaccuracies in web guidance—once the outer region 21 has been folded open, an unimprinted strip, however narrow, will be visible in the continuous printed image. To keep the width of the connected edges as narrow as possible, the printing formes for the continuing printed images, at least on the side that is to be continued, are exposed with the print image or have printing regions that are closer to the edge of the printing forme than they would otherwise ordinarily be in the case of a white image border, up to an unexposed width of no more than 20 mm, particularly no more than 15 mm, for example. This width up to the lateral printing forme edge can also be narrower if, in the printing press, printing formes to be arranged side by side on the forme cylinders are fastened not without a gap, but at slight distances from one another. This is then to be taken into consideration accordingly in the exposure process.

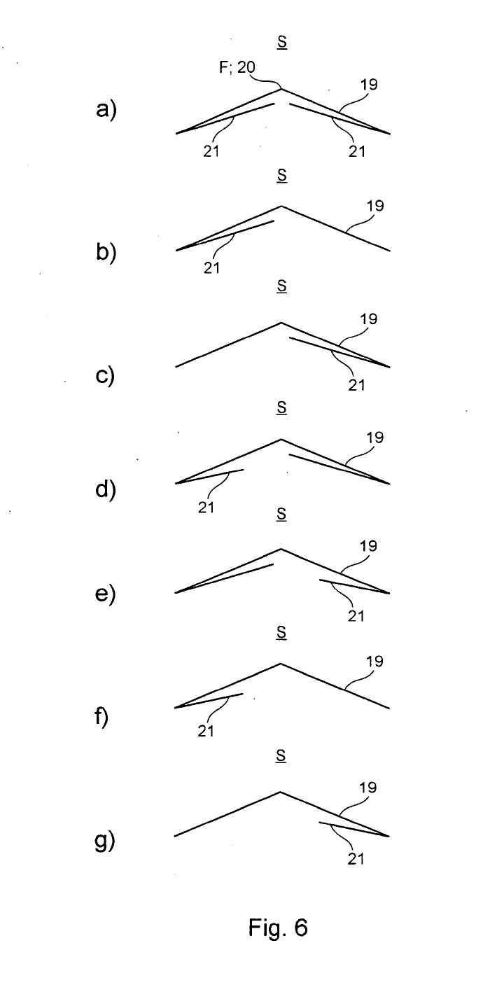

In addition to producing an extra-wide signature S with fold-out pages 21 disposed symmetrically on both sides and having the same length, which is particularly essentially one page in width (see, e.g., FIG. 6a)) or smaller (not shown), extra-wide signatures S having a fold-out page 21 disposed on one side and having substantially the length of one page width (e.g., FIGS. 6b) and 6c)) or smaller (e.g., FIGS. 6f) and 6g)), and an asymmetrical arrangement of two fold-out pages 21 with one fold-out page 21 having a length of substantially one page width and one fold-out page 21 having a shorter length (e.g., FIGS. 6d) and 6e)) can also be produced. The web strand 04a1; 04a2 is then to be produced in the superstructure 07 in an appropriate width and/or number, prior to gluing, as required for the individual examples.

In the method for producing a product P in a described newspaper printing press having at least one printing unit 02, particularly at least one printing tower 01, wherein the printing unit 02 or the printing tower 01 has a plurality of printing couples each with one forme cylinder 05, one first and at least one second web strand 04b; 04a; 04a1; 04a2 are produced by imprinting and, if applicable, cutting.

After imprinting, the first web strand 04b has two printed pages of a newspaper page side by side, for example, but particularly has one printed page that is two newspaper pages in width (double-page spread). The at least one second web strand 04a1; 04a2 is embodied as no more than two pages in width. In one advantageous embodiment, it has at least one printed page that is one newspaper page in width.

One of the two web strands 04a; 04a1; 04a2; 04b is guided above the other of the two web strands 04b; 04a; 04a1; 04a2, wherein the second web strand 04a; 04a1; 04a2 or a web strand 04a1; 04a2 produced from the second web strand 04a; 04a1; 04a2 by longitudinal slitting is adhesively joined in an outer edge region thereof, particularly by gluing, to an opposite outer edge region of the first web strand 04b, before the first web strand 04b, which is two pages in width, is guided with its at least one joined web strand 04a; 04a1; 04a2 to the fold former 13 for longitudinal folding.

In a further development, a product illustrated in FIG. 7c) can be produced, the signature S of which has an edge region 19 connected as described above on both sides of the center region 19. However, this edge region 19 is advantageously embodied as less than one page in width, preferably no more than one-half page in width. An outer region 21, joined adhesively in this manner, can be provided on only one side of the center region 19, but advantageously on both sides. In contrast to the above-described embodiments, an inner signature 31 is then additionally inserted in the region of the longitudinal fold line F—preferably on the same side of the web as the outer regions 21—and is adhesively joined, particularly by gluing, to the center region 19 of the signature S. Preferably, the inner signature 31 is joined at the center to the longitudinal fold line F of the center region 19, so that two narrow pages, the legs of which are the same length, are inserted into the longitudinally folded product. However, an asymmetrical arrangement of the inner signature 31 joined to the center region 19 in the area of the longitudinal fold line is also possible. In FIGS. 7a) and 7b), examples for the production of a product of this type or a special signature S of this type are illustrated, wherein production is based in principle on the above-described embodiments. In contrast to this, the web strands 04a1 and/or 04a2 are preferably embodied as narrower than one page in width, advantageously, for example, one-half page in width or even narrower, and an additional web strand 04a3 (or web strand 04a3 or partial web strand 04a3 produced by longitudinal slitting) is also to be disposed beneath or above the web strand 04b that is two pages in width, for example, before it runs up onto the former structure 13. Said additional web strand is then joined to the web strand 04b in the region of the longitudinal fold line thereof, upstream of or at the fold former, as these web strands are merged, by the application of glue via an additional gluing unit 14. The third web strand 04a3 can be formed by longitudinally slitting the same web 04 or the same web strand 04.a, with which one or both web strands 04a1; 04a2 that supply the outer regions 21 are also formed by longitudinal slitting. As was described in reference to FIG. 3, the web strands 04a1; 04a2 and 04a3 can be formed from the same original web 04, which is double or triple width, for example, as the web strand 04b that supplies the center region 19 (see FIGS. 3b, 5b and 7b). In another embodiment, the web strand 04b that supplies the center region 19 and the web strands 04a1; 04a2; 04a3 that supply the outer regions 21 and the inner signature can be formed from different original webs 04. In principle, it is not necessary for the three web strands 04a1; 04a2; 04a3 to originate from the same web 04 or the same web strand 04a.

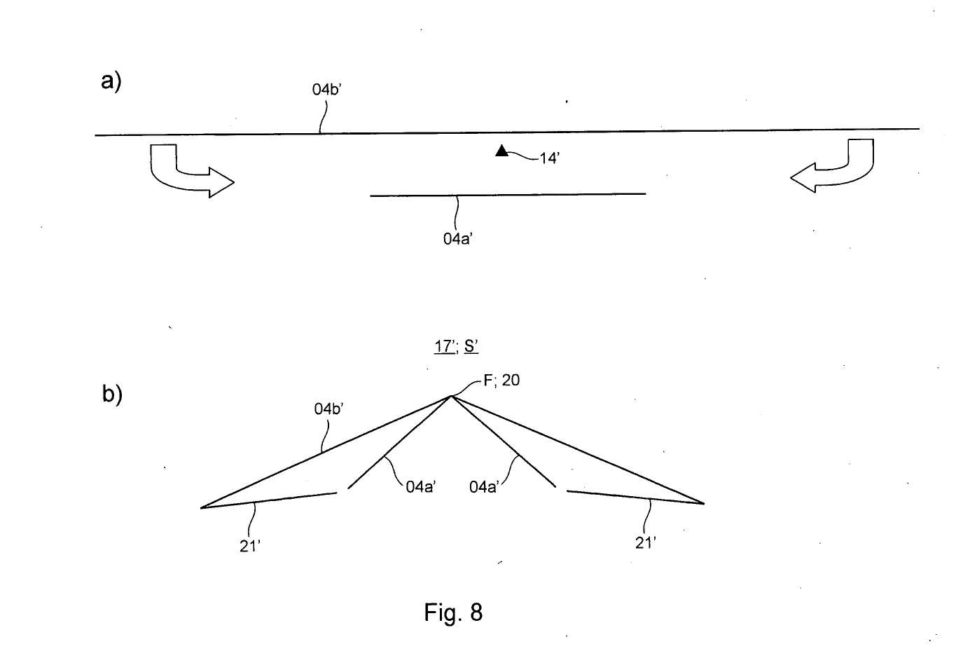

In an alternative production method for producing an extra-wide signature S′ (similar to the signature S of FIG. 7c), a web strand 04b′ that is three newspaper pages in width can be imprinted at the center with two printed pages, particularly newspaper pages, and at each of the edges with one-half newspaper page width. The web strand 04b′ that is three pages in width is then guided over a plough folder, not shown here, in such a way that the two half-width pages are each folded in onto the double page as fold-out pages 21′. This strand, which after passing through the plough folder is two pages in width and has outer regions 21′, for example, fold-out pages 21′, that are folded in and are one-half page in width, can then be joined (e.g., again by gluing via a dispensing unit 14′) at the center, on the side of the strand where the folded-in fold-out pages 21′ are, to a web strand 04a′ that is one page in width, at the strand center, for example, in a print-free region produced by an abutment line between adjacent printing formes, before the resulting strand 17′ is guided centered to the fold former. A cross-section of a strand 17′ or extra-wide signature S′ produced in this manner is illustrated in FIG. 8. In this embodiment, the forme cylinder 05′ has at least one double-width printing forme 28′, which is preferably continuous over at least three printed pages.

In the described embodiments, a transfer cylinder 29 that interacts with the respective forme cylinder 05 can have a plurality of printing blankets (blankets) two pages in width, side by side. In an advantageous further development, the transfer cylinder 29 has at least one printing blanket that extends over the entire active cylinder length.

Preferably, a plurality of webs 04; 06 are imprinted in the printing press in a plurality of printing towers 01 and are combined to form a combined product P. In one advantageous embodiment, the web 04, which is used to produce the extra-wide signature S, is guided through the active dryer 09 and/or is embodied as glazed and/or heavily coated paper, whereas the webs 06 that are used to produce other signatures L are guided without drying support and are embodied as newsprint paper.

While a preferred embodiment of a newspaper product and a method and apparatus for producing a product, in accordance with the present invention, has been set forth fully and completely hereinabove, it will be apparent to one of skill in the art that various changes in, for example, the specific structure of the printing unit and its printing couples, the drives for the printing couples, the structure of the fold formers, and of any cross-folders could be made without departing from the true spirit and scope of the present invention, which is accordingly to be limited only by the appended claims.

What is claimed is:

1-25. (canceled)

26. A newspaper product or newspaper product section comprising at least one outer signature (L), two pages in width, and at least one inner signature (L; S), at least two pages in width, wherein the at least two signatures, in the closed condition thereof, are each folded longitudinally along a longitudinal fold line (F) and are arranged one inside the other, and wherein the at least two signatures (L) have two vertical printed pages side by side or one printed image that is continuous over two vertical printed pages, on both sides of the longitudinal fold line (F), wherein the at least one inner signature (S) has a fold-out outer region (21), at least on a longitudinal side of its longitudinally folded center region (19), which is two pages in width, said side extending parallel to the longitudinal fold line (F), wherein this fold-out outer region (21) is joined by adhesion in the region of its lateral edge to the lateral edge region of the two-page-wide center region (19), and forms an extra-wide signature (S) with the center region (19), and the outer region (21), in the folded open condition, extends beyond the width of the remainder of the product (P) and forms a lateral continuation of the center region (19), wherein on the folded open extra-wide signature (S), a printed image of a continuous illustration extends across more than two pages, without a white strip.

27. The newspaper product or newspaper product section according to claim 26, characterized in that the center region (19) and the outer region (21), in the closed condition, in which they are not folded open, lie one on top of the other such that together they form a lateral edge on the longitudinal side having the adhesive connection, and/or in that the outer region (21) can be folded open from the center of the product, wherein the adhesive connection with the center region (19) is kept along the edge.

28. The newspaper product or newspaper product section according to claim 26, characterized in that a fold-out outer region (21) is provided on both sides of the center region (19).

29. A method for producing a product (P) in a printing press, particularly a newspaper printing press, comprising at least one printing unit (02) through which at least one web (04; 06) passes, wherein the printing unit (02) comprises a plurality of printing couples, each having one forme cylinder (05), wherein the product (P) to be produced has an extra-wide signature (S), comprising a center region (19), which is two pages in width and has a longitudinal fold (20), and, on at least one side of the center region (19), an outer region (21) that forms a continuation of the center region, wherein at least one first imprinted web strand (04b), which is two pages in width, and one second imprinted web strand (04a), which is embodied as no more than one page in width, or an imprinted web strand (04b; 04a; 04a1; 04a2), which is produced from the second web strand (04a) by longitudinal slitting and is embodied as no more than one page in width, are produced by the printing press, and wherein one of the two web strands (04b; 04a; 04a1; 04a2) is guided on top of the other of the two web strands (04b; 04a; 04a1; 04a2), characterized in that the second web strand (04a1; 04a2) forms the outer region (21) of the extra-wide signature (S) in the product (P), and is adhesively joined at an outer edge region to an outer edge region of the first web strand (04b), which forms the center region (19) in the product (P), before the strand (17), which results from the joining of the two web strands (04b; 04a1; 04a2) to be joined along their edges, is guided to a fold former (13) for longitudinal folding, wherein after imprinting, the first web strand (04b) has a printed page that is two newspaper pages in width, and the printed images disposed on the forme cylinders (05) for the center region (19) and the outer region (21) are exposed and/or aligned in such a way that a continuous printed image extends across more than two pages on the folded open, extra-wide signature (S).

30. The method according to claim 29, characterized in that the second web strand (04a) is slit longitudinally before being joined to the first web strand (04b).

31. The method according to claim 29, characterized in that the second web strand (04a) has two printed pages, each one newspaper page in width.

32. The method according to claim 29, characterized in that the second web strand (04a) is slit longitudinally, and one outer edge region of each of the two longitudinally slit partial web strands (04a) is adhesively joined, particularly by gluing, to the two outer edge regions of the un-slit first web strand (04b), before the un-slit first web strand (04b), which is two pages in width, is guided with its joined partial web strands (04a1; 04a2) to the fold former (13) for longitudinal folding.

33. The method according to claim 29, characterized in that the first web strand (04b) and the second web strand (04a) are produced by longitudinal slitting from the same imprinted web (04).

34. The method according to claim 29, characterized in that the one web strand (04; 04a1; 04a2) is guided onto the other web strand (04b) by turning.

35. The method according to claim 29, characterized in that the first web strand (04b) and the second web strand (04a) are produced from different webs (04) imprinted in different printing towers (01).

36. The method according to claim 29, characterized in that the web (04) receives ink via a forme cylinder (05), which has the length of at least four vertical newspaper pages.

37. The method according to claim 29, characterized in that at least one printing forme (26; 28), which is at least two newspaper pages in width, is disposed on the forme cylinder (05) and provides the first web strand (04b) with its printed image.

38. The method according to claim 29, characterized in that a glazed and/or heavily coated paper having a coat weight greater than 10 g/m² is used for the first web strand (04b) and/or the second web strand (04a) or for a web (04) which will be cut into the first and second web strands (04a; 04b).

39. The method according to claim 29, characterized in that the first web strand (04b) and/or the second web strand (04a) or a web (04) which will be cut into the first and second web strands (04a; 04b) is guided through a dryer (09).

40. The method according to claim 29, characterized in that at least one third web (06) or third web strand (06) is imprinted by another printing unit (02), particularly another printing tower (06).

41. The method according to claim 40, characterized in that the third web strand (06) is merged with the longitudinally folded strand (17) that contains the first web strand (04b) at the latest downstream of a fold former (13), to form a combined strand, and is processed in a folding apparatus (08) to form a product (P), particularly newspaper product (P).

42. The method according to claim 29, characterized in that an uncoated paper, for example, newsprint paper, is used as the web (06) that represents or contains the third web strand (06).

43. The method according to claim 42, characterized in that the third web strand (06) does not pass through an active dryer.

44. The method according to claim 40, characterized in that from the at least three web strands (04; 04a; 04b; 06), a newspaper product (P) is produced, which contains the signature (S) from the first web strand (04b) with the joined web strand (04a1; 04a2) or joined web strands (04a1; 04a2) and at least one additional signature (L) from at least one third, longitudinally folded web strand (06) that is two pages in width.

45. The method according to claim 41, characterized in that the entire strand is cross cut downstream of the fold former (13), and the resulting product sections are cross folded once before being delivered to a delivery area of the folding apparatus (08).

46. The method according to claim 29, characterized in that the at least one web (04; 06) passes substantially vertically through a printing tower (01) containing the printing unit (02), in a printing press embodied as a newspaper printing press.

47. The method according to claim 29, characterized in that the web (04; 06) is imprinted by at least one printing unit (02) embodied as an H-printing unit or satellite printing unit, particularly by at least two stacked H-printing units or satellite printing units, and/or passes substantially vertically through the stacked printing units (02).

48. The method according to claim 29 for producing a newspaper product (P) or a newspaper product section (P).

49. An apparatus for producing a product (P), which has an extra-wide signature (S) comprising a center region (19), which is two pages in width and has a longitudinal fold (20), and on at least one side of the center region (19), an outer region (21), which forms a continuation of the center region, said apparatus comprising at least one printing tower (01) through which a web (04) passes substantially vertically, wherein the printing tower (01) has a plurality of printing couples, each having one forme cylinder (05), with a superstructure (07) and with a former structure (03) having at least one fold former (13), wherein the superstructure (07) is embodied as having guide elements, such that a first web strand (04b), embodied as two pages in width and forming the center region (19) in the product (P), and a second web strand (04a; 04a1; 04a2), embodied as no more than one page in width and forming the outer region (21) in the product (P), can be guided on top of one another in such a way that the lateral edges thereof lie in the same alignment at least on the same side of the strand, wherein upstream of the former structure (03), on the web path of one of the two webs (04) or web strands (04a; 04b; 04a1; 04a2), a dispensing unit (14) is disposed so as to apply adhesive material to an edge region of one of the two webs (04) or web strands (04a; 04b; 04a1; 04a2), in such a way that the two web strands (04b; 04a1; 04a2) are in contact with one another as they are merged upstream of the former structure (03) or on a roller (16) disposed upstream of a fold former (13), and can be adhesively joined to one another along the edge by the adhesive material (15) to form a strand (17), and the print images for the center region (19) and the outer region (21), disposed on the forme cylinders (05), are exposed and/or aligned in such a way that a continuous printed image extends across more than two pages on the folded open extra-wide signature (S).

50. The apparatus according to claim 49, characterized in that a printing forme relating to the outer region (21) and a printing forme relating to the adjoining center region (19) are exposed in such a way that on the side of each printing forme that forms a continuation of the respective print image, the same print image section is provided in an overlapping region measuring at least 1 mm.
